(19) United States
(12) Patent Application Publication
(10) Pub. No.: US 2012/0248704 A1
(43) Pub. Date: Oct. 4, 2012

(54) FILM RIDING SEAL FOR TURBINES

(75) Inventors: Cyril William Fennell, Newbold Verdon (Leicester) (GB); Vassilis Stefanis, Whetstone (Leicester) (GB)

(73) Assignee: ALSTOM TECHNOLOGY LTD., Baden (CH)

(21) Appl. No.: 13/432,920

(22) Filed: Mar. 28, 2012

(30) Foreign Application Priority Data
Mar. 29, 2011 (CH) 00569/11

(51) Int. Cl. F16J 15/34

(52) U.S. Cl. 277/360; 277/358; 277/388

(57) ABSTRACT

An seal is described for a turbine with a first sealing surface mounted on a stationary part of a turbine and a second sealing surface mounted on a rotating part of the turbine, the surfaces being structured such that in operation the thin film of a fluid medium is generated between the two surfaces reducing contact and/or leakage with at least one of the first or second sealing surface mounted such that it is subject to a retracting force which opens the seal while stationary or at slow rotation speeds of the turbine and subject to a force counteracting the retracting force at operational rotation speeds of the turbine. The surface of the sealing face may incorporate patterns straight or helical in nature to help induce the fluid into the gap and maintain the fluid film.

### RELATED APPLICATION

The present application hereby claims priority under 35 U.S.C. Section 119 to the Swiss Patent Application Number 00569/11, filed Mar. 29, 2011, the entire contents of which are hereby incorporated by reference.

### FIELD OF INVENTION

The present invention relates to a seal mounted between rotating and static parts of a turbine, particularly between the tip of a rotating turbine blade and static casing or extensions thereof.

### BACKGROUND

In the following description the term “turbine” is used to refer to rotary engines having a stator and a rotating part force coupled by a fluid medium such as water or gas. Of particular interest for the present invention are axial turbines comprising radially arranged fixed stator blades or vanes alternating with radial arrangements of moving rotor blades. Movements are generally registered as movements relative to a casing or housing.

Many parts of the turbine encounter efficiency loss due to the fluid medium leaking into parts of the turbine outside the desired flow path. Important leakage paths are located for example between the rotor and the casing, or between the tips of the static blades or guide vanes and the rotor. Another problem encountered in the design and operation of turbines is the leakage between the tip of the rotor blades and the housing. The operation of a radial turbine requires a minimum of tip clearance between the rotating running blades and the stationary wall casing. This gap gives rise to a leakage flow driven by the pressure difference between the pressure side and the suction side. The same problem appears between to the turbine rotor and casing in the area of the balance piston and is herein also subsumed for sake of clarity under tip leakage.

To reduce leakage and in particular tip leakage it is known to close the gap between the rotating parts and the static parts by appropriate seals. The most common type of seal used for this purpose is the labyrinth seal. A labyrinth seal has typically a number of radially extending annular projections on one part and a corresponding annular seal and on the other part or an arrangement of threads or grooves. All variants have the common feature of providing a tortuous path for the fluid through the gap. For a turbine, the seal often takes the shape of a complete ring usually assembled as halves or quarter segments within and supported by the casing.

As labyrinth seals are well known, it suffices for the purpose of the present invention to emphasize that such seals are complex shapes requiring exacting dimension tolerances to function properly. Any movement of the parts of the seal from their default positions or wear during operation generates an usually significant increase of leakage or friction between the moving and the static part.

To accommodate relative movement of the parts of the seal in case of a radial expansion or shrinkage of the blade, some seals are assembled as spring-backed packages. In a spring-backed seal, the elastic force pushes one part of the seal against the other and thus avoids widening gaps or excessive friction when the moving blades shrink or expand.

Known alternatives to the labyrinth seals are brush seals and finger seals. These seals include generally a plurality of flexible members mounted on one part which form a seal with a suitable surface on the other part.

A further known alternative, which is however less commonly applied, is the film riding seal with two engaging surfaces. As the turbine rotates, a thin film of fluid is generated between the surfaces with a small lifting force to keep them apart. Typically an elastic element is included in the seal design to exert a restoring force, which counters the lifting force and maintains an approximately constant gap between sealing surfaces.

However, given that film riding seals require a very accurate finishing and control of the sealing surfaces and their distance, this particular type of seal has not found wide-spread use in the power generating industry. It is therefore seen as an object of the invention to improve known film riding seals to accommodate the demanding environment of large turbines, particularly large steam turbines as used in power generation for the public grid.

### SUMMARY

The present disclosure is directed to a turbine seal including a first sealing surface mounted on a stationary part of a turbine and a second sealing surface mounted on a rotating part of the turbine. The surfaces being structured such that in operation a thin film of a fluid medium is generated between the two surfaces reducing contact and/or leakage with at least one of the first or second sealing surface mounted such that at least one of the first or second sealing surface is subject to a retracting force which opens the seal while stationary or at slow rotation speeds of the turbine and subject to a force counteracting the retracting force at operational rotation speeds of the turbine.

### BRIEF DESCRIPTION OF THE DRAWINGS

Exemplary embodiments of the invention will now be described, with reference to the accompanying drawings, in which:

FIG. 1 presents a schematic cross-section of a (known) steam turbine to illustrate the environment in which the present invention is placed;

FIGS. 2A and 2B show schematic examples of a film riding seal in accordance with the present invention oriented in axial direction and steam feed through the shroud of the rotating turbine blades;

FIG. 3 shows schematically a film riding seal in accordance with the present invention oriented in axial direction and steam feed through the carrier of the sealing surface which is connected to the static casing;

FIG. 4 shows schematically film riding seals in accordance with the present invention oriented in axial direction and steam feed through the static carrier of the sealing surface with two seals arranged as a pair to improve axial sealing;

FIG. 5 shows schematically a film riding seal in accordance with the present invention placed on an extension of the shroud oriented in radial direction and steam feed through the carrier of the sealing surface connected to the static casing;

FIG. 6 shows another example of a film riding seal in accordance with the present invention oriented in radial direction with steam feed through the carrier of the sealing surface connected to the static located between additional seals placed on castellations; and

FIG. 7 shows an example of a surface structure of surfaces forming a film riding seal in a schematic cross-section.

### DETAILED DESCRIPTION OF THE PREFERRED EMBODIMENTS INTRODUCTION TO THE EMBODIMENTS

According to an aspect of the present invention, there is provided a seal for a turbine which includes a first sealing surface mounted on a stationary part of a turbine and a second sealing surface mounted on a rotating part of the turbine, the surfaces being structured such that in operation a thin film of a fluid medium is generated between the two surfaces reducing contact and/or leakage with at least one of the first or second sealing surface mounted such that the least one of the first or second sealing surface is subject to a retracting force which opens the seal while stationary or at slow rotation speeds of the turbine and subject to a force counteracting the retracting force at operational rotation speeds of the turbine.

In a preferred variant of the invention the sealing surfaces are mounted at a shroud or tip of a turbine blade and the adjacent static parts of the turbine.

In a preferred variant of the invention at least one surface is connected to a fluid feed line providing pressurized fluid into a space behind the sealing surface such that the pressure of the fluid contributes to the force counteracting the retracting force at operational rotation speeds of the turbine.

At least one of the surfaces of the sealing face can be patterned with for example straight or helical steps to aid guiding the fluid into the gap and to maintain the fluid film.

In another preferred embodiment of the above aspect of the invention, at least one of the sealing surfaces is mounted on a carrier capable of expanding in axial direction within a support structure. In a variant of this embodiment the carrier is supported by the casing.

In a further embodiment of the above aspect of the invention, at least one of the sealing surfaces is mounted with a flexible element to provide the retracting force acting to disengage the two surfaces of the seal.

In another embodiment of the above aspect of the invention, the two sealing surfaces are mounted perpendicular to the axial direction of the turbine. The particular advantage of this embodiment is to accommodate a larger amount of radial expansion or shrinkage of the turbine blade without affecting the gap width between the sealing surfaces.

In an alternative to this embodiment, the two sealing surfaces can be mounted perpendicular to the radial direction of the turbine. Such an embodiment has the advantage of being less sensitive to a relative displacement of the seal parts in the axial direction.

In the above variants of the invention a fluid feed line can pass through the shroud of the rotating blade or through the (static) carrier supported by the casing. In the former case the fluid line provides a conduit from the upstream side of the blade into the space behind the sealing face, whereas in the latter case the conduit connects an upstream stage of turbine with the space behind the sealing face.

In a more preferred embodiment of the above variants, the fluid line includes a circumferential (with respect to the main axis of the turbine) groove or channel.

In another preferred embodiment the seal is arranged as a twin pair of film sealing faces, preferably mounted onto the casing or static diaphragm such that the tip of the rotating blade is sealed from two sides in axial direction.

It is also feasible to provide additional extension elements to the tip or shroud of the rotating blade to narrow the gap between the tip of the blade or shroud and the casing. These extensions can take the form of fins and castellations and can be used as part of the support for one of the sealing surfaces or as support for additional seals such as labyrinth seals placed adjacent to the film riding seal.

These and further aspects of the invention will be apparent from the following detailed description and drawings as listed below.

### DETAILED DESCRIPTION

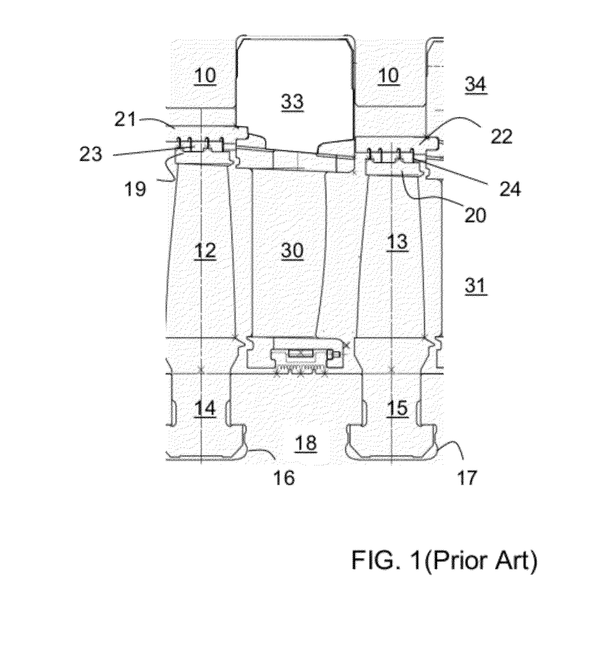

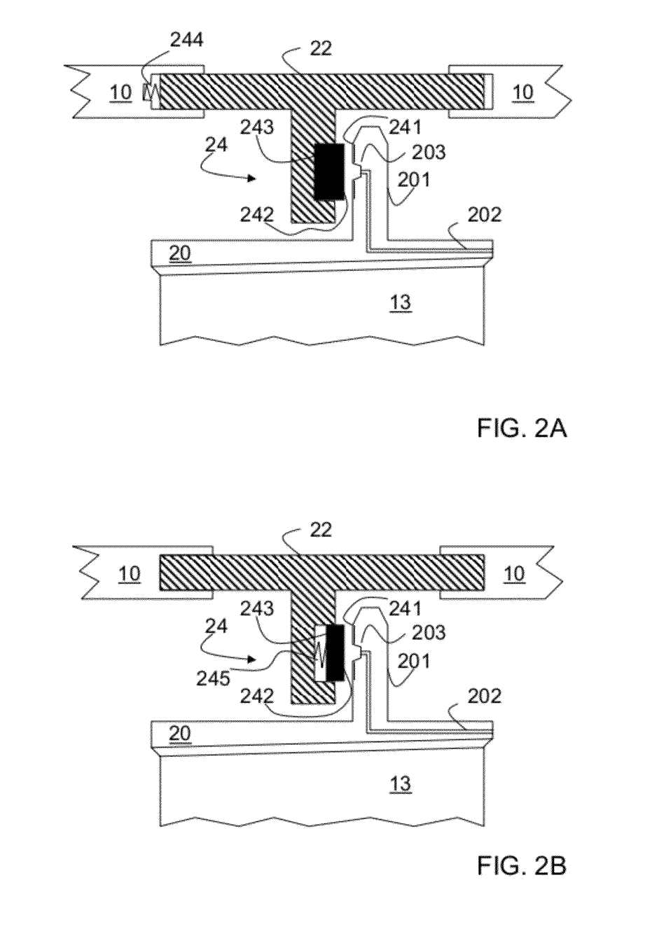

Aspects and details of examples of the present invention are described in further details in the following description referring first to a so-called “compact diaphragm” design as illustrated by FIG. 1, which reproduces the relevant features of FIG. 2 of the co-owned published United States Patent Application Publication No. 2008/0170939.

Shown in FIG. 1 is a partial radial sectional sketch of an axial flow turbine, showing a section of rings of stationary blades or diaphragm located between successive annular rows of moving blades 12, 13 in a steam turbine. The moving blades are each provided with radially inner “T-root” portions 14, 15 located in corresponding slots 16, 17 machined in the rim of a rotor drum 18. Their tips are also provided with radially outer elements referred to as shrouds 19, 20. In the example shown the shrouds carry the moving parts of a labyrinth seal. The circumscribing segmented rings, 21, 22 support the static part of the seal. These are rigidly connected to the upstream and downstream diaphragm rings 33, 34, which in turn are mounted within the casing 10 of the turbine. Connected to the diaphragm rings 33, 34 are the static vanes 30, 31. As known, sealing between the blade tips or shrouds 19, 20 and the rings 21, 22 is accomplished by lips or fins 23, 24, which are caulked into grooves machined in the segmented rings 21, 22, thus forming a conventional labyrinth seal.

In the following description the labyrinth seal of FIG. 1 is replaced by film riding seals in various arrangements as further detailed below making reference to FIGS. 2-5. Throughout the drawings, like elements or elements having like functions are designated, when possible, by the same numerals.

Referring to FIG. 2A, there is shown the tip section 13 of a rotating turbine blade with the shroud 20 carrying a radial extension element 201. Mounted onto the extension part is a first sealing face or runner face 241 of the film riding seal 24. The sealing face 241 is oriented perpendicular to the axial direction. Juxtaposed to the first sealing face or runner face 241 is a second sealing face 242, which is actually part of a seal pad 243. The rotating sealing face 241 includes typically a hard coating whereas the static seal face 242 is typically made of a softer material, which can vary, depending on the operating temperatures, from polymeric material such as PTFE to steel or carbon.

The seal pad 243 is mounted within a recess of a larger carrier element 22. A spring element 244 provides a small force to centralize the carrier 22, and pushes the sealing faces into contact in the absence of any other forces, e.g., during the start-up of the turbine. The carrier 22 resides within a slot within the casing 10 or a part connected to the casing, such as the outer diaphragm. The slot supports the carrier also including gaps to accommodate a thermal expansion in the axial direction of the carrier structure within the casing 10.

Feed lines 202 are provided by a plurality of bores through the radial extension element 201 and the shroud 20 directing steam from the upstream side (with high pressure) into the gap between the sealing surfaces 241, 242. At its entry point the bore 202 is best angled such that it points into the direction of rotation on the upstream side to make use of the velocity head.

It should be noted that the bore shown is purely schematic and its path will depend on several design parameters. These parameters include the dimensions of the shroud, the pressure differences and others. The ideal trajectory of the bores is likely to be a straight line from a location at which the pressure on the upstream side is high to the channel 203, which distributes the high pressure fluid evenly along the circumferential first sealing face or runner face 241 of the film riding seal 24.

Under operating conditions, the steam enters the feed pipe 202 from the higher pressured side to be discharged into the distributing channel 203 and into the gap between the sealing surfaces 241, 242, which is typically at a lower pressure due to the pressure loss around the tip of the blade or shroud 20. This injection of a fluid together with the relative rotation and any surface structure of the sealing surfaces 241, 242 create a thin film of fluid between the rotating and static part in this section. The thin film is to a certain degree self-adjusting in width and the seal gap can be maintained within very small tolerances.

As the opposing seal faces 241, 242 are perpendicular to the axial direction; they are tolerant against significant movement of the blade in radial direction. Any radial expansion or shrinkage results essentially only in a lateral misalignment of the sealing faces 241, 242 without however widening the gap between the two. As a result the axially oriented film riding seal is seen as potentially overcoming one of the important obstacles which so far hampered the adoption of this sealing technique in the turbine industry.

A variant of the example of FIG. 2A is shown in FIG. 2B. Here, a spring element 245 is introduced to act directly onto the sealing pad 243. The spring acts as a small closing force on the pad and can either replace the centralizing spring element 244 shown in FIG. 2A or act in combination with it. Other elements of FIG. 2B are already described above.

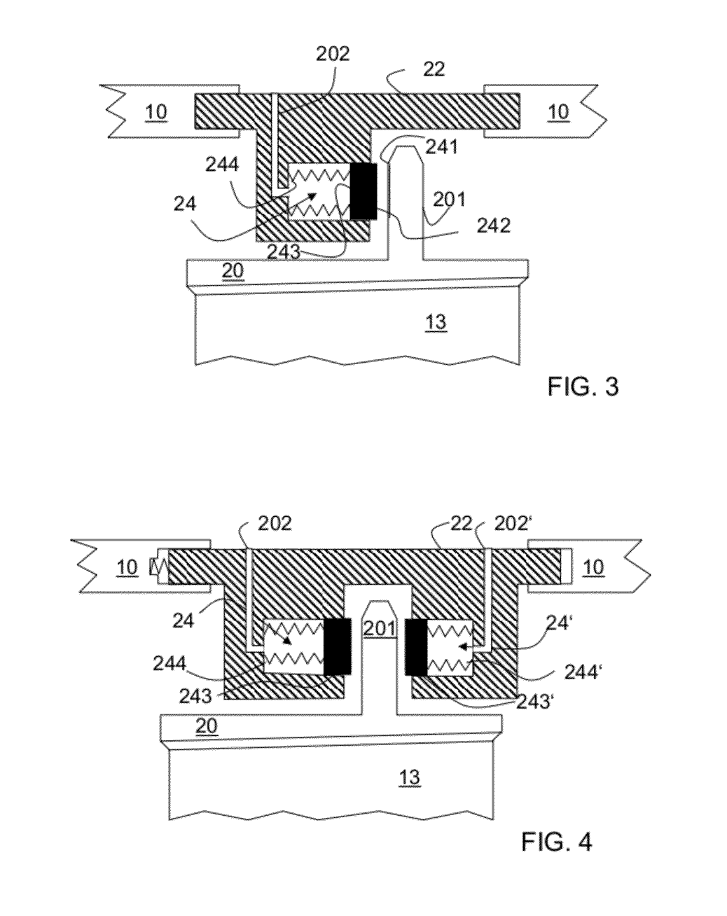

An alternative to the above-described examples is illustrated in FIG. 3. Here the fluid feed line 202 is directed from an upstream stage with higher pressure through the static carrier section 22. The pressurized fluid is guided into a space behind the seal pad 243. The bellow or spring elements 246 between the seal pad 243 and the carrier 22 are used to bias the seal and ensure the sealing position during start-up of the turbine or other non-operational events by providing a retracting force.

As with the previous example, the opposing seal faces 241, 242 are again oriented perpendicular to the axial direction and thus tolerant against movement of the blade in radial direction.

A variant of the example of FIG. 3 is shown in FIG. 4. In the example of FIG. 4, the radial extension 201 of the shroud 20 is placed between and carries the rotating faces of a pair of film riding seals 24, 24′. Each of the seals 24, 24′ is built in the same manner as seal 24 of FIG. 3 above and reference signs denote the same elements. The variant of FIG. 4 offers an improved sealing with a greater tolerance against a relative motion of the parts in axial direction.

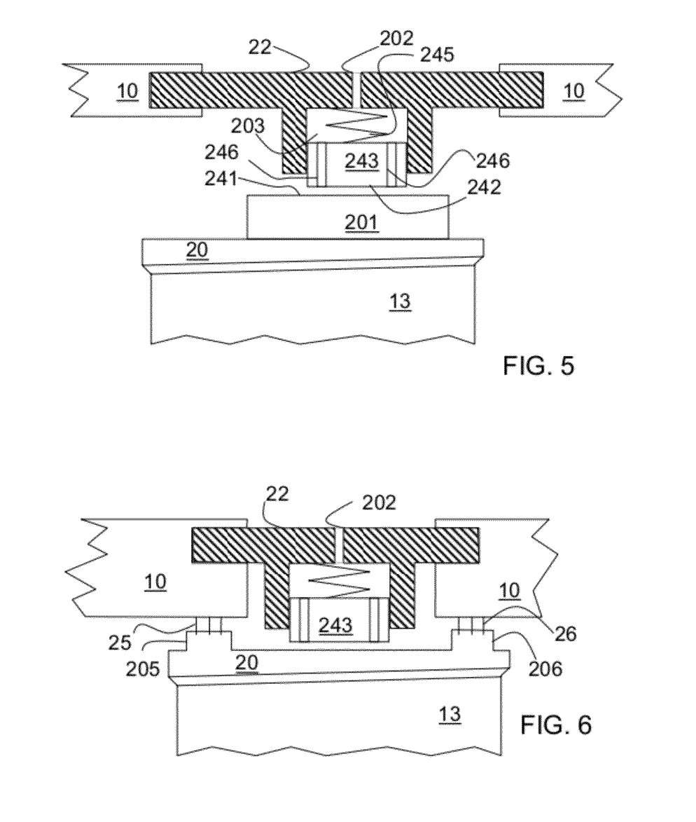

Under a different set of design constraints it may important to provide a film riding seal that is oriented in radial direction. Seals with this orientation have a greater tolerance against an axial motion of turbine rotor. Examples of embodiments devised for this purpose are shown in the following FIG. 5.

In the example illustrated by FIG. 5, the seal 24 is mounted in a groove within the carrier 22 and aligned with its sealing surfaces 241, 242 being perpendicular to the radial direction. In this radially oriented film riding seal arrangement, the steam feed 202 can be directed straight through the carrier structure into the pressure distribution channel 203 behind the sealing pad 243. The bellow 246 provides a retracting force to bias the seal.

The steam supplied in the pressure distribution channel 203 moves the seal pad against the retracting force of the bellows 246, which being designed as an opening force in this case retracts the seal pad, to close the seal once the pressure force exceeds the spring force of the bellow. A film formed by the steam leaking over the shroud and entering between the sealing faces will avoid the contact between the pad and the shroud. This variant offers the advantage of using high pressure steam to reduce the operating clearance, without introducing any additional leakage flows. The system will balance itself when the hydrodynamic force is large enough to balance the pressure force acting on the seal pad.

The sealing face 241 is part of a tip extension or castellation 201 of the shroud 20. In this embodiment the circumferential seal pad 243 is advantageously manufactured in the form of interlocking tiles, which allow for a radial expansion together with the casing 10 without pressure leakage in axial direction.

The carrier 22 resides within a slot within the casing 10 or a part connected to the casing. The slot supports the carrier leaving however gaps to accommodate a (thermal) expansion of the carrier structure.

It can be also advantageous to provide additional seals in the area of the tip 20 of the turbine blade 13 as shown in an exemplary manner in FIG. 6. In this example, the actual film riding seal 24 is enclosed with respect to the upstream and downstream pressure between two additional labyrinth seals 25, 26 mounted on the extension elements 205, 206 in a conventional manner.

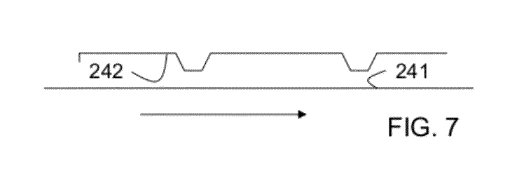

A patterned surface as illustrated in the schematic cross-sectional view of FIG. 7 can often support in the initial built-up of the film and its maintenance during rotation. Such a pattern can be for example small steps or grooves, which may be straight as shown or helical, cut into the surface 242. An arrow indicates the direction of the rotation between the static 242 and rotating surface 241. It is worth noting that a structured surface as illustrated in FIG. 7 can support the effectiveness of any of the above embodiments of the invention.

The present invention has been described above purely by way of example, and modifications can be made within the scope of the invention. The invention may also comprise any individual features described or implicit herein or shown or implicit in the drawings or any combination of any such features or any generalisation of any such features or combination, which extends to equivalents thereof. Thus, the breadth and scope of the present invention should not be limited by any of the above-described exemplary embodiments. Alternative features serving the same, equivalent or similar purposes may replace each feature disclosed in the specification, including the drawings, unless expressly stated otherwise.

Unless explicitly stated herein, any discussion of the prior art throughout the specification is not an admission that such prior art is widely known or forms part of the common general knowledge in the field.

### LIST OF REFERENCE SIGNS AND NUMERALS

casing 10
moving blades 12, 13
radially inner “T-root” portions 14, 15
corresponding slots 16, 17
rotor drum 18
shrouds 19, 20
radial extension element 201
feed pipe 202, 202′
pressure distributing channel 203
extension elements 205, 206
stator seal support, carrier 21, 22
seal/seal fins 23, 24, 24′
first sealing face or runner face 241
second sealing face 242
seal pad 243, 243′
spring elements, bellows 244, 245, 246
openings 246
labyrinth seals 25, 26
stationary blades 30, 31
upstream and downstream diaphragm rings 33, 34

1. A turbine seal comprising a first sealing surface mounted on a stationary part of a turbine and a second sealing surface mounted on a rotating part of the turbine, the surfaces being structured such that in operation a thin film of a fluid medium is generated between the two surfaces reducing contact and/or leakage with at least one of the first or second sealing surface mounted such that at least one of the first or second sealing surface is subject to a retracting force which opens the seal while stationary or at slow rotation speeds of the turbine and subject to a force counteracting the retracting force at operational rotation speeds of the turbine.

2. The seal of claim 1, wherein one of the sealing surfaces is connected to a fluid feed line providing pressurized fluid into a space behind at least one of the sealing surfaces such that the pressure of the fluid contributes to the force counteracting the retracting force at operational rotation speeds of the turbine.

3. The seal of claim 1, wherein the sealing surfaces are essentially perpendicular to the main axis of the turbine.

4. The seal of claim 2, wherein the fluid feed line comprises a bore through a shroud connecting the space behind at least one of the sealing surfaces to fluid at an upstream pressure.

5. The seal of claim 2, wherein the fluid feed line comprises a bore through the stationary part of a turbine connecting the space behind at least one of the sealing surfaces to fluid at an upstream pressure.

6. The seal of claim 2, wherein the fluid feed line comprises a circumferential channel equalizing the pressure along the space behind at least one of the sealing surfaces.

7. The seal of claim 1, wherein at least one of the sealing surfaces is mounted onto a seal pad directly or indirectly connected to an elastic element to provide the retracting force acting to disengage the two surfaces of the seal.

8. The seal of claim 1, wherein the sealing surfaces are mounted at a shrouded tip of turbine blades and the adjacent static parts of the turbine.

9. The seal of claim 8, wherein two pairs of first and second sealing surfaces are oriented essentially perpendicular to the main axis of the turbine the shrouded tip of turbine blades running between the pair.

10. The seal of claim 1, wherein the first sealing surface mounted on a stationary part of a turbine is mounted on a carrier element, which in turn has sufficient clearance to allow for thermal expansion of the casing without dislocating the seal.

11. The seal of claim 1, further comprising seals placed at a tip of rotating turbine blades to seal the passage of fluid around the tip from an upstream side to a downstream side of the blades.

12. The seal of claim 1, wherein the sealing surfaces are essentially perpendicular to the radial direction.

13. The seal of claim 12, wherein the sealing surfaces are mounted onto a radial extension of a shroud or of a tip of rotating turbine blades.

14. The seal of claim 1, wherein at least one of the sealing surfaces is patterned to facilitate the generation of the fluid film between the surfaces.
